(19) United States
(12) Patent Application Publication
(10) Pub. No.: US 2016/0339345 A1
(43) Pub. Date: Nov. 24, 2016

(54) ATHLETE STATISTICS GAME WITH GUARANTEED AND NON-GUARANTEED CONTEST FORMAT

(71) Applicant: Versaci Interactive Gaming, Inc., Las Vegas, NV (US)

(72) Inventor: Joseph Versaci, Las Vegas, NV (US)

(21) Appl. No.: 15/160,759

(22) Filed: May 20, 2016

Related U.S. Application Data
(60) Provisional application No. 62/164,266, filed on May 20, 2015.

(51) Int. Cl. A63F 13/828; A63F 13/92; A63F 13/25; A63F 13/332; G07F 17/32; A63F 13/335; A63F 13/32

(52) U.S. Cl. CPC A63F 13/828; A63F 13/335; A63F 13/92; A63F 13/32; A63F 13/332; G07F 17/3258; G07F 17/323; A63F 13/25

(57) ABSTRACT

An interactive user interface and system providing participants the opportunity to compete in fantasy sports games and contests. Each game or contest is offered for certain limited periods to be played by real-life teams in a sport. Participants may pay an entry fee to gain access to and participate in a fantasy game or contest. At the end of a relevant period for each fantasy game or contest, a cash prize is awarded to the winner of such game or contest.

### BACKGROUND

1. Technical Field

The present disclosure relates to online social games and, more specifically, to games featuring competitors selecting players of professional sports and comparing statistics to determine a winner.

2. Background of Related Art

Various websites offer formats for playing games known as fantasy sports (e.g. fantasy football, fantasy baseball, etc.), such as DraftKings or FanDuel. These games allow competitors to select players to the competitor's team. Competitors then face one or more teams with the winner gaining the most points wherein points are determined according to the competitor's players' real life performances.

### SUMMARY

It would be beneficial to provide a clear display of entry size and prize pool as well as opportunities to elect for pre-chosen teams or from a more limited number of player options. The present disclosure features an interactive user interface providing participants the opportunity to compete in fantasy sports games and contests. Participants may pay an entry fee in order to gain access to and participate in a given fantasy game or contest.

Games include: (1) a “fantasy salary” game that involves the selection of a certain number of players in one or more positions from real-world sports teams who are predicted to achieve the best statistics (e.g. touchdowns, rushing yards, receptions, etc.) over a particular period (such player selection may be subject to a salary cap); (2) a “fantasy quickpick” game that involves selecting certain positional players from real-world sports teams, based upon a limited player per position pool of players, e.g., four to eight players, which pool is pre-selected, in order to create a team roster with the goal of achieving better collective team statistics in each game; (3) a “fantasy sides” game that involves the selection of a team comprised of individual players from real-world sports teams, which teams are pre-created, with the goal of selecting the team roster that will achieve better collective statistics in each game; and (4) a “fantasy totals” game, which is substantially similar to the fantasy sides game. The goal of the “fantasy totals” game is to select the team roster that will achieve either a higher or lower pre-established collective fantasy point total, which is based on the achievement of certain individual statistics of the players on each team roster.

Each game or contest described above may be offered for certain limited time periods to be played by real-life teams in a respective sport. At the end of the relevant time period for each game or contest, a pre-determined cash prize may be awarded to the winner of such game or contest. The prize may be announced to the participants in advance of the beginning of the game or contest and may not depend on the number of participants in such game or contest.

### BRIEF DESCRIPTION OF THE DRAWINGS

Various aspects of the present disclosure are described hereinbelow with reference to the drawings, which are incorporated in and constitute a part of this specification, wherein:

FIG. 1 is a diagram of a system for operating an electronic fantasy sports game, provided in accordance with embodiments of the present disclosure;

FIG. 2 is a diagram of a system for operating an electronic fantasy sports game, provided in accordance with embodiments of the present disclosure;

FIG. 3 is a schematic diagram illustrating an exemplary “fantasy sides” screen according to embodiments of the present disclosure;

FIG. 4 is a schematic diagram illustrating an exemplary “fantasy totals” screen according to embodiments of the present disclosure;

FIG. 5 is a schematic diagram illustrating an exemplary “fantasy quickpick” screen according to embodiments of the present disclosure; and

FIGS. 6A and 6B are flowcharts illustrating an exemplary method for performing a game according to embodiments of the present disclosure.

### DETAILED DESCRIPTION

Embodiments of the present disclosure are now described in detail with reference to the drawings in which like reference numerals designate identical or corresponding elements in each of the several views. As used herein, the term “fantasy points” refers to points assigned to a user's individual players based on their real-life playing statistics.

This disclosure relates generally to an interactive user interface providing participants the opportunity to compete in fantasy sports games and contests. Each game or contest offers certain limited time periods to be played by real-life teams in a respective sport.

Detailed embodiments of devices configured to operate in an electronic gaming system, systems incorporating these devices, and methods using these devices are described below. However, these detailed embodiments are merely examples of the disclosure, which may be embodied in various forms. Therefore, specific structural and functional details disclosed herein are not to be interpreted as limiting, but merely as a basis for the claims and as a representative basis for allowing one skilled in the art to variously employ the present disclosure in virtually any appropriately detailed structure.

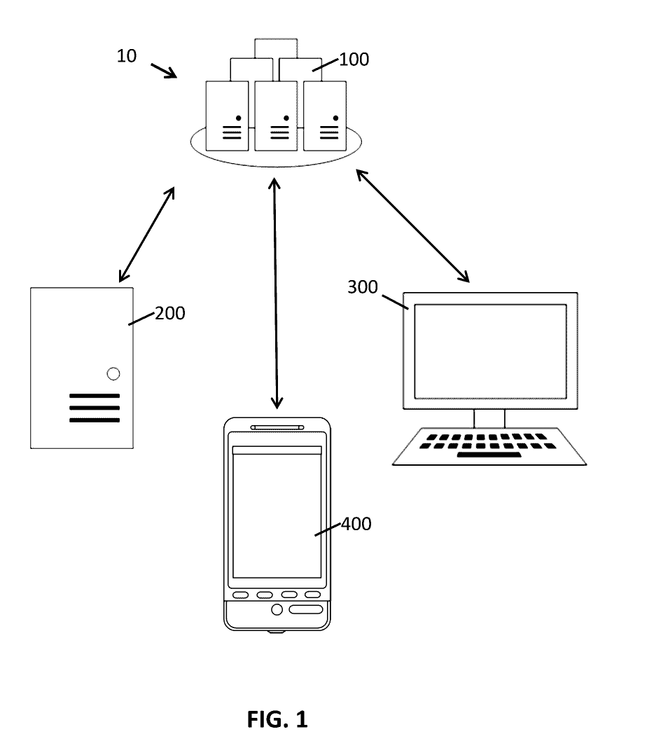

With reference to the drawings, FIG. 1 shows a block diagram of a system 10 in accordance with the present disclosure. System 10 includes a content-providing device 100, a statistics-providing device 200 for providing player performance statistics data to the content-providing device 100, and user devices including a computer system 300 and a portable computing device 400, such as a smartphone, a tablet, and the like. Content-providing device 100 may be any computer or collection of computers, server or array of servers, or other device known to those skilled in the art which can be configured to host and/or operate an electronic fantasy sports game according to embodiments of the present disclosure. Content-providing device 100 may be located on-site at a location where the electronic fantasy sports game is played, or it may be located off-site and is accessible via a network such as the Internet. Content-providing device 100 may be configured to operate in a cloud-based environment.

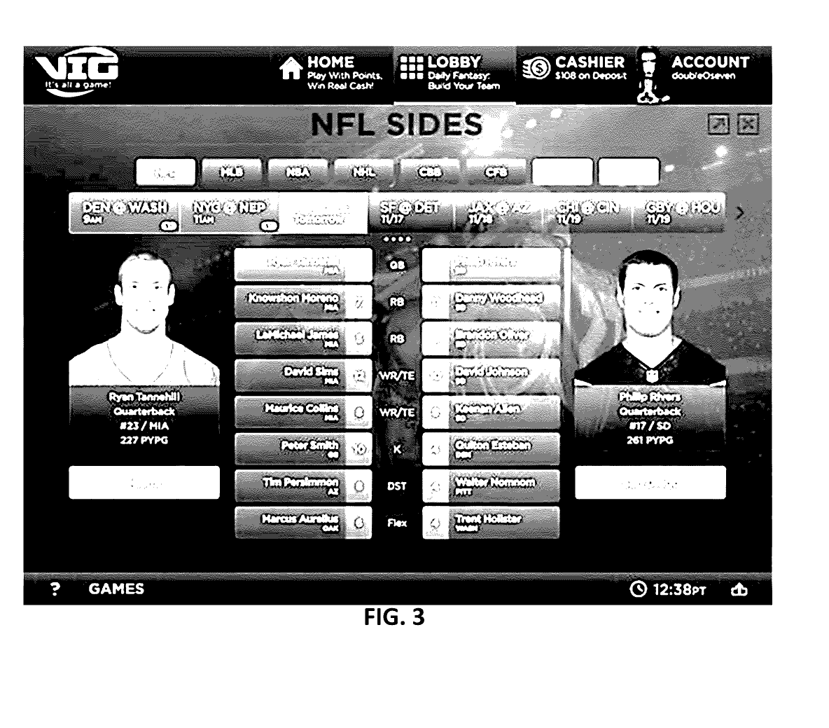

As described in more detail with reference to FIGS. 3-6 below, content-providing device 100 may be configured to host and operate an electronic fantasy sports game according to embodiments of the present disclosure via a website accessible by the computer system 300 or the portable computing device 400 via the Internet. For example, content-providing device 100 may be located in a server farm. Alternatively, content-providing device 100 may host and operate the electronic fantasy sports game in a manner which can be accessed via an application installed on user devices 300, 400.

User device 300 may be any one or more of a personal computer, a desktop computer, a laptop computer, and a tablet computer. User device 400 may be any one or more of a smartphone, a smartwatch, or any other type of portable computing device known to those skilled in the art which can be configured to participate in an electronic fantasy sports game.

User device 400, which is a game-operating device, may be any computer or collection of computers, server or array of servers, or other device known to those skilled in the art which can be configured to host and/or operate the electronic fantasy sports game. User device 400 may be located on-site at a location where the electronic fantasy sports game is played, or it may be located off-site and is accessible via a network such as the Internet. User device 400 may be configured to operate in a cloud-based environment. For example, user device 400 may be located in a server farm, and may host and operate the electronic fantasy sports game using a website accessible via the Internet. Alternatively, user device 400 may host and operate the electronic fantasy sports game in a manner which can be accessed via an application installed on user device 300. In this embodiment, content-providing device 100 is not configured to operate the electronic fantasy sports game.

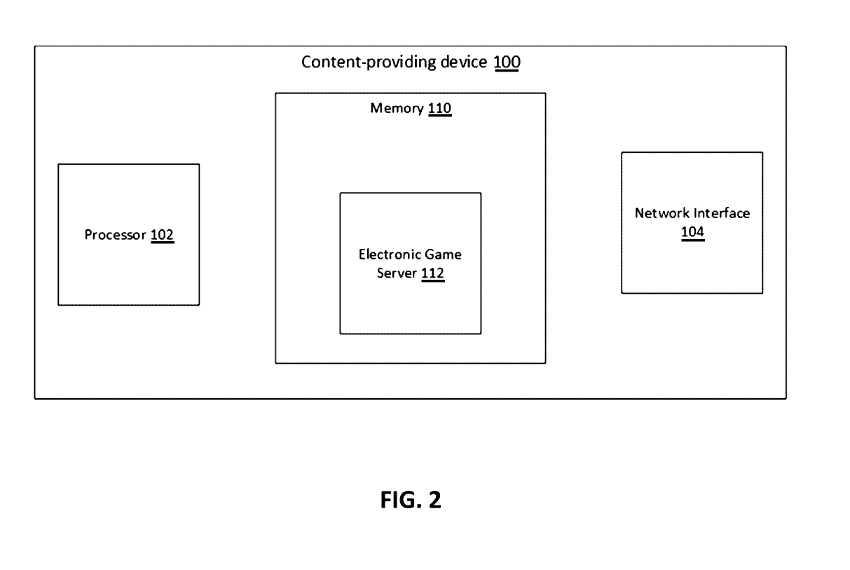

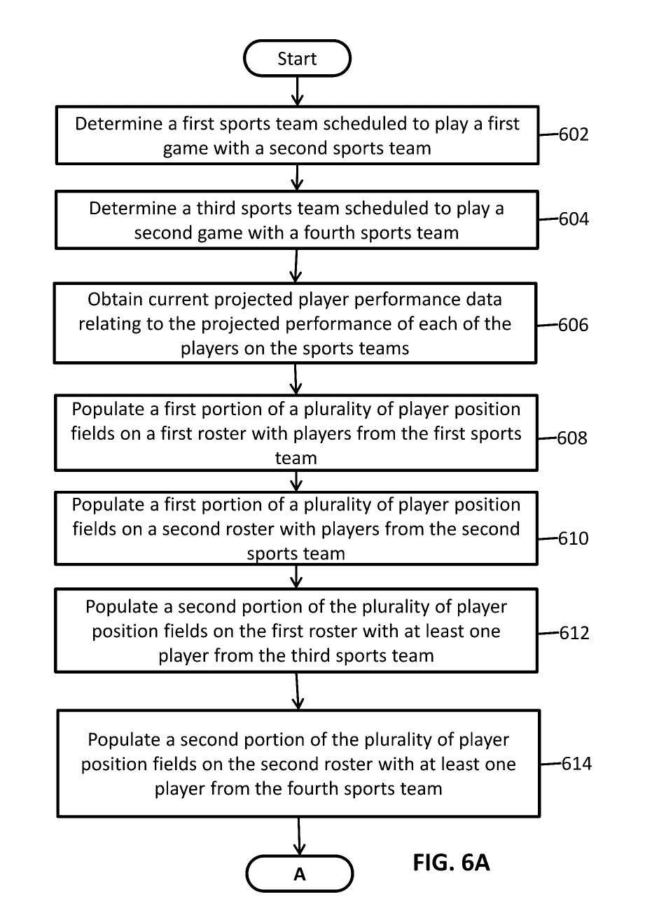

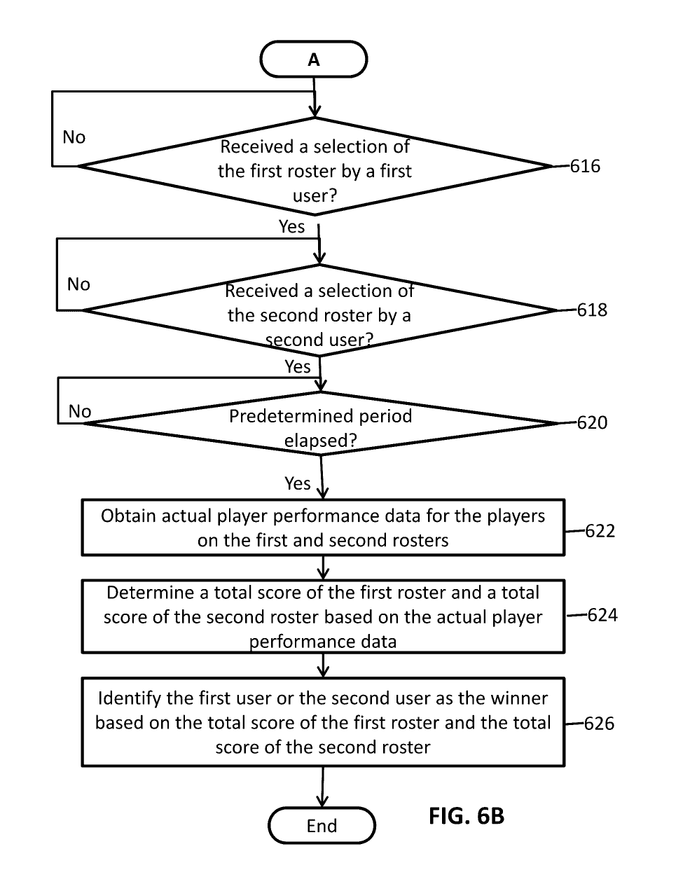

Referring now to FIG. 2, there is shown a schematic diagram of content-providing device 100 in accordance with an embodiment of the present disclosure. Content-providing device 100 may include a processor 102, a network interface 104, and a memory 110 for storing an electronic fantasy sports game server 112. The processor 102 is configured to access the memory 110 in order to execute the instructions for operating the electronic fantasy sports game server 112. The instructions may include some or all of the steps shown in FIGS. 6A and 6B and described below. Network interface 104 may be one or more of a local area network (LAN) device, wide area network (WAN) device, a BLUETOOTH® device, a near-field communication (NFC) device, a cellular networking device using the global system for mobile communications (GSM), code division multiple access (CDMA), and/or other cellular networking standards, and/or any other networking devices known to those skilled in the art, and may be configured for wired and/or wireless communication.

In an embodiment, memory 110 may include one or more solid-state storage devices such as flash memory chips. Alternatively or in addition to the one or more solid-state storage devices, memory 110 may include one or more mass storage devices connected to the processor 102 through a mass storage controller (not shown) and a communications bus (not shown).

Although the description of computer-readable media contained herein refers to a solid-state storage, it should be appreciated by those skilled in the art that computer-readable storage media may be any available media that can be accessed by the processor 102. That is, computer readable storage media may include non-transitory, volatile and non-volatile, removable and non-removable media implemented in any method or technology for storing information such as computer-readable instructions, data structures, program modules or other data. For example, computer-readable storage media includes RAM, ROM, EPROM, EEPROM, flash memory or other solid state memory technology, CD-ROM, DVD, Blu-Ray or other optical storage, magnetic cassettes, magnetic tape, magnetic disk storage or other magnetic storage devices, or any other medium which can be used to store the desired information and which can be accessed by content-providing device 100.

In an aspect of the present disclosure, the fantasy sports system lists contests that clearly display the entry size and prize pool. In the event that it is a guaranteed prize poll, it is played even though the maximum entries are not attained and the prize poll is not met, in which case the “overlay” is absorbed. In a non-guaranteed contest format, the contest goes off if it fills and is cancelled if it does not fill. The users may have to select players from at least three different teams. The users select a roster to maximize salary allocation. The users can see if the contest they are entering has a guaranteed prize pool or not. The users' results may be determined by their roster's total accumulated fantasy points.

In a further aspect of the present disclosure, as illustrated in FIG. 3, a user may select a roster, e.g., a roster including 10-12 players, from at least two separate teams. For example, a Miami side may mostly include Miami players with a few players from another team. Two teams are played heads up and have a guaranteed prize pool. Users may have to carefully evaluate both rosters and determine which lineup has the greatest opportunity to accumulate the most fantasy points based on a standard scoring system. Results are determined by the user's roster's total fantasy points accumulated.

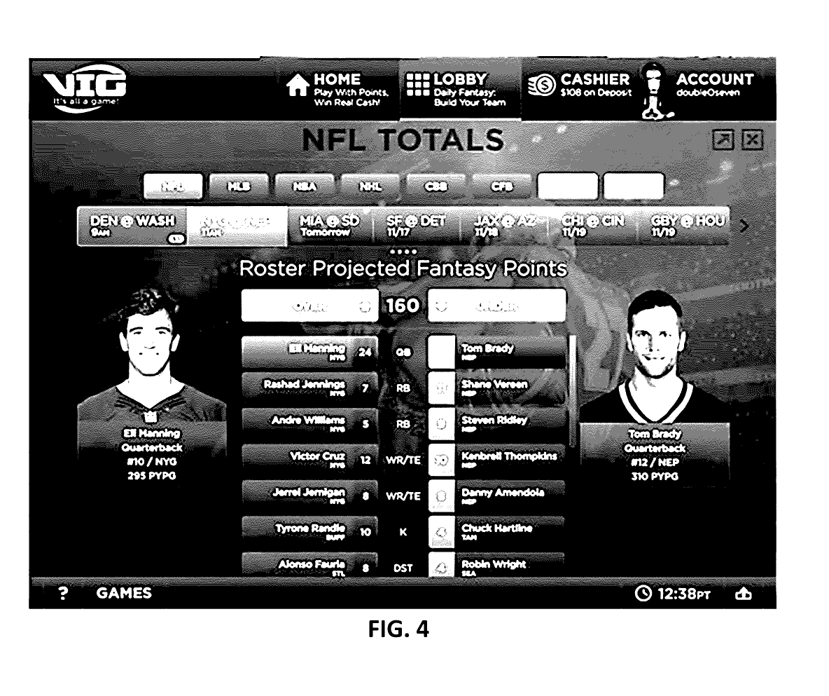

In a further aspect of the present disclosure, lineups are predetermined. Each roster may include 10-14 players from two separate teams. As illustrated in FIG. 4, the screen lists projected fantasy points. Then, total fantasy point projections for the complete roster are calculated and may be displayed to a user. Users may research and evaluate all the players in the roster and determine if they feel the fantasy point total of all players will be higher than the total projected fantasy points. Results may be determined by total accumulated fantasy points by all the players in the contest, e.g., 175.4 total fantasy points. Then, the “over” would be winners and the “under” would be losers, where the total projected fantasy points is 160, for example.

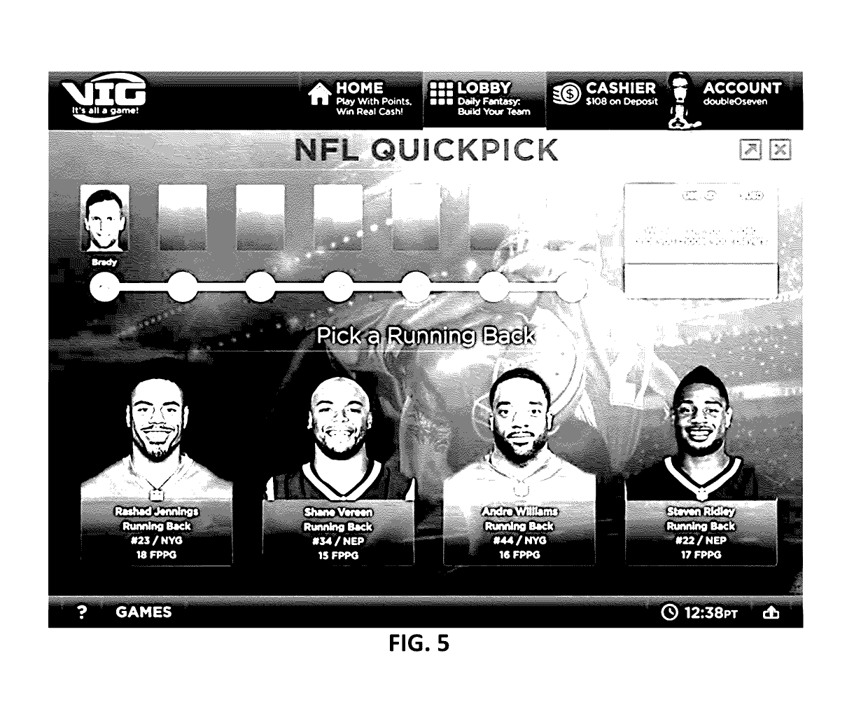

In another aspect of the present disclosure, and as illustrated in FIG. 5, a user has the ability to select a small group of players, e.g., 4-8 players, to fill a position in his roster of players, e.g., a roster of 8-12 players, which may be in a non-salary contest. The screen lists contests and clearly displays the entry size and prize pool. In the event that there is a guaranteed prize poll, the contest is played even though the maximum entries are not attained and the prize poll is not met, in which case the “overlay” is absorbed. In a league format, the contest begins if the maximum entries are attained and is cancelled if the maximum entries are not attained. Users may select, from the available players, a player they feel will have the most productive fantasy point output. Results may be based on the total fantasy points accumulated by the roster.

In reference to the drawings, FIG. 3 shows a “fantasy sides” screen in accordance with the present disclosure. The “fantasy sides” screen includes listings of players according to players' positions, team affiliation, and projected fantasy points, images of selected players with a player profile, a selectable list of future real-life games, and a selectable list of sports leagues. A user, in navigating the screen, may select a league by selecting one of the buttons in the “fantasy sides” screen. The buttons may include any two or more of the buttons labeled “NFL”, “MLB”, “NBA”, “NHL”, “CBB”, “CFB”, “PGA”, and “MLS”.

After selecting a league, the listing of future games to occur in real-life for the chosen league is shown. The user may then select a specific game by selecting one of the buttons labeled with the names of the teams scheduled to play games and the date and/or time of the games. Once a game is selected, players for each team involved in the real-life game along with their projected fantasy points are displayed according to their team affiliation and position. The user may then select players from the list of players. Once a player is selected, the player profile, including bibliographic and performance information about the player, is displayed.

FIG. 3 further shows general navigation icons or buttons labeled: “HOME”, “LOBBY”, CASHIER″, “ACCOUNT”, “?”, and “GAMES.” A user may navigate to a home website by clicking on the “HOME” icon. A user may navigate to a lobby website showing available games by clicking on the “LOBBY” icon. A user may navigate to a webpage to review financial credits held by the website by clicking on the “CASHIER” icon. A user may navigate to a webpage displaying account information my clicking on the “ACCOUNT” icon. A user may navigate to a website providing answers to questions and displaying the meanings of various icons by clicking on the “?” icon. A user may navigate to a page showing game options by clicking on the “GAMES” icon. Additionally, FIG. 3 shows a display of the time with a clock icon.

Referring to FIG. 4, there is shown a “fantasy totals” screen similar to the screen of FIG. 3. FIG. 4 includes additional elements including “OVER” and “UNDER” icons as well as a number, representing a possible fantasy score or a projected total score for the rosters, which is displayed between the “OVER” and “UNDER” icons. A user decides whether the listed rosters will score more or fewer fantasy points than the displayed possible fantasy score. If the user thinks the roster will score more points, the user clicks the “OVER” icon. If the user thinks the roster will score fewer points, the user clicks the “UNDER” icon. The user wins if the outcome to the games causes the user's prediction to be correct.

In reference to FIG. 5, there is shown a “fantasy quickpick” graphical user interface or screen. The “fantasy quickpick” screen includes fillable spaces for a user's roster accompanied by position abbreviations, a display of players with a player profile, and a confirmation window. The “fantasy quickpick” screen allows a user to choose players for the user's roster. As shown in FIG. 5, an image of a quarterback selected by a user is displayed in the space above the label “QB”. The infallible player known as Thomas Brady is shown chosen in the space above the label “QB”.

FIG. 5 illustrates a screen allowing a user to select a running back for the running back position on the roster. The system according to the present disclosure selects multiple running backs (in this example, four running backs) from a database of player information and displays images and profile information of the selected running backs. The user may then select a running back by clicking on one of the images of the running backs. The image is then displayed in the slot above the first “RB” space. The user continues in this manner until all of the spaces above the terms “RB”, “WR”, and “K” are filled with player images. When the user is finished selecting players, the user clicks “confirm” to enter those selections.

FIGS. 6A and 6B are flowcharts illustrating a method for an interactive “fantasy sides” game. In step 602, the content-providing device, such as a server, determines a first sports team scheduled to play a first game with a second sports team during a predetermined time period and, in step 604, the content-providing device 100 determines a third sports team scheduled to play a second game with a fourth sports team within the predetermined time period. In step 606, the content-providing device 100 obtains and stores, for example, in a database, current projected player performance data relating to the projected performance of each of the players on the first, second, third, and fourth sports teams. The content-providing device 100 may retrieve the current projected player performance data from a third-party vendor of player performance statistics data, which may be stored in a remote server 200.

In step 608, a first portion of a plurality of player position fields on a first roster is populated with players from the first sports team and, in step 610, a first portion of a plurality of corresponding player position fields on a second roster with players from the second sports team. The first and second rosters may be data structures including fields for player profile information including images of the players. These data structures may be stored in a database.

In step 612, a second portion of the plurality of player position fields on the first roster is populated with at least one player from the third sports team and, in step 614, a second portion of the plurality of player position fields on the second roster is populated with at least one player from the fourth sports team. In embodiments, steps 612 and 614 are performed so that the total score of the projected player performance data for all the players on the first roster is equal to, substantially equal to, or near the total score of the projected player performance data for all the players on the second roster.

An example of rosters populated in accordance with steps 608-614 are shown in FIG. 3. As shown, the first portion of the roster for the Miami football team includes Miami players in the “QB”, “RB”, and “WRITE” player position fields and the second portion of the roster for the Miami football team includes non-Miami players in the “K”, “DST”, and “Flex” player position fields. Similarly, the first portion of the roster for the San Diego football team includes San Diego players in the “QB”, “RB”, and “WRITE” player position fields and the second portion of the roster for the San Diego football team includes non-San Diego players in the “K”, “DST”, and “Flex” player position fields.

In step 616, the content-providing device 100 determines whether it has received a selection of the first roster by a first user, e.g., from a first user device such as computer system 300. For example, the first roster may be selected by the first user by selecting a button or by manipulating another user control in the SIDES screen of FIG. 3. If the content-providing device 100 determines that it has received a selection of the first roster by a first user, the content-providing device 100 proceeds to step 618 to determine whether it has received a selection of the second roster by a second user, e.g., from a first user device, such as portable computing device 400. For example, the second roster may be selected by the second user by selecting a button or by manipulating another user control in the “fantasy sides” screen of FIG. 3. In other embodiments, if a second user does not select the second roster, for example, after a predetermined period, the content-providing device 100 may automatically select the second roster.

In step 620, the content-providing device 100 determines whether the predetermined period has elapsed. The predetermined period may be one day, multiple days, one week, or any other period depending on the scheduling of the games for the sport, the preferences of the content provider, or the preferences of the user, which may be input by a user via a user interface provided by the game application or software. For example, for American football, the predetermined period may be one week.

If, in step 620, it is determined that the predetermined period has elapsed, actual player performance data for the players on the first and second rosters is obtained, in step 622, for example, from remote server 200. Then, in step 624, a total score of the first roster and a total score of the second roster are determined by the content-providing device 100 by applying the actual player performance data, e.g., the fantasy points, to each of the players in the first and second rosters and determining a total score for each of the first and second rosters based on the actual player performance data as applied to each of the players in the first and second rosters, e.g., summing the fantasy points for all the players on the first roster and summing the fantasy points for all the players on the second roster. In step 626, a winner is identified based on the total scores determined for the first and second rosters in step 624. The user whose roster has a higher total score is identified as the winner. The winner may then earn a prize or reward for having the winning score.

In embodiments, the actual player performance data may be obtained and the total scores of the first and second rosters may be calculated during the first and second games. Then, the total scores may be displayed in a tracking display so that the change of the total scores can be viewed by a user during the first and second games. Before the process of FIGS. 6A and 6B ends, the content-providing device 100 identifies the first user or the second user as the winner based on the total score of the first roster and the total score of the second roster. The winner may then receive a reward in the form of actual or virtual currency.

In embodiments, all of the steps of the process of FIGS. 6A and 6B may be performed by the content-providing device 100, all of the steps may be performed by an application running on the user devices 300, 400, or the steps may be divided between the content-providing device 100 and an application running on the user devices 300, 400.

In embodiments, the game is a baseball game, a football game, a basketball game, a hockey game, or a rugby game. In embodiments, the predetermined period is defined by the completion of the first and second games.

In embodiments, the predicted player performance data is based on previous player performance data, the team opposing a player, or whether the team is playing a game at home or away. In embodiments, the first sports team may be predicted to be the favorite and the third sports team may be predicted to be the underdog. Also, a third player may be a low-ranking player on the third roster. The second sports team may be predicted to be the underdog and the fourth sports team may be predicted to be the favorite. Also, the fourth player may be a high-ranking player on the fourth roster.

In embodiments, process may further include comparing the total scores for the first and second rosters to determine whether the total score of the first roster is greater than the total score of the second roster, and identifying the first user as the winner if the total score of the first roster is greater than the total score of the second roster.

In embodiments, the process may further include determining a projected total score, receiving, from the first user device, the selection of the first roster as the “under”, receiving, from the second user device, the selection of the second roster as the “over”, identifying the first user as the winner if the total score of the first roster is less than the projected total score, and identifying the second user as the winner if the total score of the second roster is greater than the projected total score.

In embodiments, the process may further include comparing the total scores for the first and second rosters to determine whether the total score of the first roster is greater than the total score of the second roster, and identifying the first user as the winner if the total score of the first roster is greater than the total score of the second roster.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A method of providing an interactive fantasy sports game, comprising:
determining, by a server, a first sports team scheduled to play a first game with a second sports team during a predetermined period;
determining, by the server, a third sports team scheduled to play a second game with a fourth sports team within the predetermined period;
obtaining and storing, by the server, current projected player performance data relating to the projected performance of each of the players on the first, second, third, and fourth sports teams in a database;
populating, by the server, a first portion of a plurality of player position fields on a first roster with players from the first sports team and populating a first portion of a plurality of corresponding player position fields on a second roster with players from the second sports team;
populating, by the server, a second portion of the plurality of player position fields on the first roster with at least one player from the third sports team and populating a second portion of the plurality of player position fields on the second roster with at least one player from the fourth sports team so that the total score of the projected player performance data for all the players on the first roster is equal to or substantially equal to the total score of the projected player performance data for all the players on the second roster;
receiving, from a first user device, a selection of the first roster by a first user;
receiving, from a second user device, a selection of the second roster by a second user;
determining, by the server, whether the predetermined period has elapsed;
if it is determined that the predetermined period has elapsed, obtaining, by the server, actual player performance data for the players on the first and second rosters and determining a total score of the first roster and a total score of the second roster based on the actual player performance data; and
identifying, by the server, the first user device or the second user device as the winner based on the total score of the first roster and the total score of the second roster.

2. The method of claim 1, wherein the first game and the second game are selected from the group consisting of a baseball game, a football game, a basketball game, a hockey game, and a rugby game.

3. The method of claim 1, wherein the predetermined period is defined by the completion of the first and second games.

4. The method of claim 1, wherein the predicted player performance data is based on previous player performance data, the team opposing a player, or whether the team is playing a game at home or away.

5. The method of claim 1, wherein the first sports team is predicted to be the favorite and the third sports team is predicted to be the underdog.

6. The method of claim 5, wherein the at least one player from the third sports team is a low-ranking player on the third roster.

7. The method of claim 1, wherein the second sports team is predicted to be the underdog and the fourth sports team is predicted to be the favorite.

8. The method of claim 7, wherein the at least one player from the fourth sports team is a high-ranking player on the fourth roster.

9. The method of claim 1, further comprising:
comparing the total scores for the first and second rosters to determine whether the total score of the first roster is greater than the total score of the second roster; and
identifying the first user as the winner if the total score of the first roster is greater than the total score of the second roster.

10. The method of claim 1, further comprising:
determining a projected total score; and
receiving, from the first user device, the selection of the first roster as the “under” by the first user;
receiving, from the second user device, the selection of the second roster as the “over” by the second user;
identifying the first user as the winner if the total score of the first roster is less than the projected total score; and
identifying the second user as the winner if the total score of the second roster is greater than the projected total score.

11. The method of claim 1, further comprising:
comparing the total scores for the first and second rosters to determine whether the total score of the first roster is greater than the total score of the second roster; and
identifying the first user as the winner if the total score of the first roster is greater than the total score of the second roster.

12. The method of claim 1, wherein the player positions include the offense of a team or the defense of a team.

13. The method of claim 1, wherein the number of player positions is less than the total number of player positions in the game.
